(19) United States
(12) Patent Application Publication
(10) Pub. No.: US 2023/0275376 A1
(43) Pub. Date: Aug. 31, 2023

(54) Plug-in Connection Element, and a Device for Monitoring a Plug-in Connection Element

(71) Applicant: Bayerische Motoren Werke Aktiengesellschaft, Muenchen (DE)

(72) Inventors: Stephan RIESS, Friedberg (DE); Simon SCHOENLEBER, Schwabhausen (DE)

(21) Appl. No.: 18/020,111

(22) PCT Filed: Jul. 7, 2021
(86) PCT No.: PCT/EP2021/068750

§ 371 Date: Feb. 7, 2023

(30) Foreign Application Priority Data
Aug. 17, 2020 (DE) 10 2020 121 544.4

(51) Int. Cl. H01R 13/68; B60L 53/16

(52) U.S. Cl. CPC H01R 13/68; B60L 53/16; H01R 2201/26

(57) ABSTRACT

A plug-in connection element for a plug-in connection includes an electrically conductive first contact part which is configured to form an electrically conductive connection with a complementary first contact part of a complementary plug-in connection element of the plug-in connection. The plug-in connection element also includes at least one further electrically conductive part, and at least one protective element which is configured to reduce an electrical resistance between the first contact part and the further part as the temperature increases.

### BACKGROUND AND SUMMARY OF THE INVENTION

The invention relates to a plug-in connection element for a high-voltage plug-in connection, e.g., in a motor vehicle. Furthermore, the invention relates to a device for protecting or for monitoring a plug-in connection element.

An electric drive vehicle (e.g., a PHEV, Plug-In Hybrid Electric Vehicle, or a BEV, Battery Electric Vehicle) comprises at least one electrical energy store (e.g., a battery) that can be attached to a charging station via a charging device of the vehicle and charged. The electrical energy from the electrical energy store can be conducted to an electrical drive motor of the vehicle via electrical lines to operate the drive motor and to drive the vehicle. The electrical lines used to transmit electrical drive energy may be referred to as power lines. Typically, a direct current is transmitted from the electrical energy store to the drive motor (in particular, to an inverter of the drive motor) via the conductors of a power line. The voltage or the potential difference between a conductor pair of a power line is typically in the region of 300V or more. A power line can therefore also be referred to as a high-voltage (HV) line.

A line for the transmission of electrical energy typically has a shielding, in particular an EMC (electromagnetic compatibility) shielding, running around the line. The power can be connected to another component, e.g., to an inverter, via a plug-in connection. In this case, an overload, in particular an overheating, of the plug-in connection or of a plug-in connection element of the plug-in connection may occur during operation.

The present document addresses the technical problem of providing efficient and reliable protection of a high-voltage plug-in connection element for a plug-in connection.

The problem is solved by the claimed invention. It is noted that additional features of a claim dependent on an independent patent without the features of the independent patent or only in combination with a subset of the features of the independent patent can form an invention in its own right that is independent of the combination of all features of the independent patent and that can be made the subject of an independent claim, a divisional application or a subsequent application. This applies in the same way to technical teachings described in the description, which may form an invention independent of the features of the independent claims.

According to one aspect, a plug-in connection element (e.g., a plug or a socket) for a plug-in connection is described. The plug-in connection element (e.g., the plug) comprises an electrically conductive first contact part which is designed to form an electrically conductive connection with the complementary first contact part of a complementary plug-in connection element (e.g., the socket) of the plug-in connection. The first contact part may be at a first potential, e.g., at a positive potential, in particular at a high voltage (HV)+ potential, e.g., at +150V or higher.

Furthermore, the plug-in connection element comprises at least one further electrically conductive part (e.g., a reference part or a second contact part). The first contact part and the further part should be electrically isolated from each other in a normal operation. In other words, the electrical resistance between the first contact part and the further part should be greater than a specified resistance threshold value (e.g., 500 MOhm or more).

As already explained above, the further part can comprise or can be a reference part, in particular a reference layer or shielding layer surrounding the first contact part. The reference part can be connected to a reference potential, in particular to the (vehicle) ground.

Alternatively or additionally, the further part can comprise or can be an electrically conductive second contact part designed to form an electrically conductive connection with a complementary second contact part of the complementary plug-in connection element of the plug-in connection. The second contact part can be at a second potential, e.g., at a negative potential, in particular at an HV potential, e.g., at −150V or lower.

The first contact part and/or the second contact part can each be connected to a conductor of at least one power line. The power line can run, e.g., between an electrical energy store (e.g., with a nominal voltage of 300V or higher) and the plug-in connection element.

The plug-in connection element comprises at least one protective element which is designed to reduce the electrical resistance between the first contact part and the further part (in particular the reference part and/or the second contact part) as the temperature (of the plug-in connection element and/or the first contact part) increases. In particular, the protective element can be designed to abruptly reduce the electrical resistance between the first contact part and the further part as soon as the temperature (of the plug-in connection element and/or the first contact part) reaches or exceeds a predefined temperature threshold value. The decreasing resistance can be detected by a monitoring device, and consequently an increased temperature of the plug-in connection element and/or the first contact part can be detected by the device in an efficient and reliable manner. In response, one or more protective measures can then be effected to protect the plug-in connection element (e.g., decoupling the plug-in connection element from the electrical energy store (in particular from an HV storage device).

The protective element can comprise a dielectric and/or electrically insulating material arranged between the first contact part and the further part. The protective element (in particular the dielectric and/or electrically insulating material) can be designed to melt as soon as the temperature reaches or exceeds the predefined temperature threshold value. In this way, the electrical resistance can be reduced in a particularly efficient and reliable manner in dependence on the temperature.

Alternatively or additionally, the protective element can comprise a bimetal arranged between the first contact part and the further part. The bimetal of the protective element can be designed to effect (by deformation of the bimetal) an electrically conductive connection between the first contact part and the further part as soon as the temperature reaches or exceeds the predefined temperature threshold value. In this way, the electrical resistance can be reduced in a particularly efficient and reliable manner in dependence on the temperature.

According to a further aspect, a further plug-in connection element for a plug-in connection is described. The features of the plug-in connection elements described in this document can be combined in any desired manner.

The plug-in connection element (e.g., a plug or a socket) comprises an electrically conductive first contact part designed to form an electrically conductive connection with a complementary first contact part of the complementary plug-in connection element of the plug-in connection.

Furthermore, the plug-in connection element comprises a safety line which is designed to form an electrically conductive connection with a complementary safety line of the complementary plug-in connection element of the plug-in connection when (in particular as soon as) the first contact part is electrically conductively connected to the complementary first contact part. The safety line can thus be used to reliably monitor whether the plug-in connection is or exists in a correctly plugged state.

The plug-in connection element further comprises at least one protective element which is designed to increase an electrical resistance between the safety line and the complementary safety line as the temperature increases. In particular, the protective element can be designed to abruptly increase the electrical resistance between the safety line and the complementary safety line (in particular, the electrically conductive connection between the two safety lines can be interrupted) as soon as the temperature reaches or exceeds the predefined temperature threshold value.

The increase in resistance on a safety line can be detected by a monitoring device as an indication of increased temperature. In response, one or more safety measures can then be effected to protect the plug-in connection element.

The protective element may comprise an electrically conductive material (in particular a metal) arranged between the safety line and the complementary safety line. The protective element (in particular the electrically conductive material) can be designed to melt as soon as the temperature reaches or exceeds the predefined temperature threshold value. In this way, the electrical resistance can be increased in a particularly efficient and reliable manner in dependence on the temperature.

Alternatively or additionally, the protective element may comprise a bimetal arranged between the safety line and the complementary safety line. The bimetal of the protective element can be designed to interrupt the electrically conductive connection between the safety line and the complementary safety line as soon as the temperature reaches or exceeds the predefined temperature threshold value. In this way, the electrical resistance can be increased in a particularly efficient and reliable manner in dependence on the temperature.

A plug-in connection element described in this document can be designed for electrical voltages of 300V or higher and/or for electrical currents of 1 A or more. Furthermore, a plug-in connection element described in this document can be designed for installation in a (motor) vehicle, in particular for installation in a power path of an electrical prime mover of an electrically driven vehicle.

According to a further aspect, a device for monitoring a plug-in connection element described in this document is described, wherein the plug-in connection element is electrically conductively coupled (during normal operation) to an electrical energy store.

The device is set up to detect resistance data relating to the electrical resistance influenced by the protective element of the plug-in connection element (in dependence on temperature). Furthermore, the device is set up to decouple the plug-in connection element from the energy store in dependence on the resistance data, in particular when the electrical resistance is greater than or less than a specified resistance threshold value. In this way, reliable protection of the plug-in connection element can be effected.

According to a further aspect, a (motor) vehicle, in particular a road motor vehicle, such as a passenger car or a truck or a bus or a motorcycle, is described comprising at least one plug-in connection element described in this document and/or the device described in this document.

It should be noted that the methods, devices, and systems described in this document can be used alone or in combination with other methods, devices, and systems described in this document. Furthermore, any aspects of the methods, devices, and systems described in this document can be combined in a variety of ways. In particular, the features of the claims can be combined in a variety of ways.

The invention is described in greater detail below with reference to exemplary embodiments.

### BRIEF DESCRIPTION OF THE DRAWINGS

FIG. 1 shows a block diagram of an exemplary charging system for a vehicle energy storage system.

FIG. 2 shows an example of wiring inside a vehicle.

FIG. 3a shows an exemplary plug-in connection element in a frontal view of the contact parts of the plug-in connection element.

FIG. 3b shows an exemplary plug-in connection element in a side view transverse to the contact parts.

FIG. 3c shows an exemplary plug-in connection element in a further side view transverse to the contact parts.

FIG. 4 shows an exemplary plug-in connection with two plug-in connection elements of complementary design.

FIG. 5 shows a monitoring device for a plug-in connection element.

### DETAILED DESCRIPTION OF THE DRAWINGS

As stated at the outset, the present document deals with reliable and efficient temperature monitoring of a plug-in connection element of a plug-in connection.

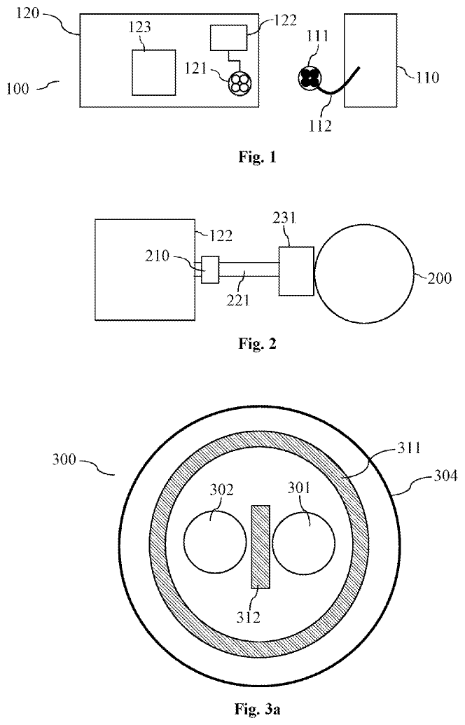

In this context, FIG. 1 shows a block diagram of an exemplary charging system 100 comprising a charging station 110 and a vehicle 120. The vehicle 120 comprises an electrical energy store 122 that can be charged with electrical energy from the charging station 110. The vehicle 120 comprises a charging interface, in particular a charging socket, 121 to which a corresponding plug 111 of a charging cable 112 can be plugged. The charging socket 121 and the plug 111 form a plug-in system. The vehicle 120 comprises a control unit 123 that is set up to control a charging process at the charging station 110.

FIG. 2 shows an example of wiring in a vehicle 120. In particular, FIG. 2 shows one or more power lines 221 that connect an electrical load 200 (e.g., an electrical prime mover or an inverter) to the electrical energy store 122 via a power plug-in connection 231 to transmit electrical supply energy to the electrical load 200.

At a plug-in connection 231, in particular within a plug-in connection element of a plug-in connection 231, an overload may occur during operation and, as a consequence, overheating may occur. This document describes measures with which such a situation can be identified in a reliable and efficient manner and with which one or more suitable countermeasures can be effected to protect the plug-in connection element.

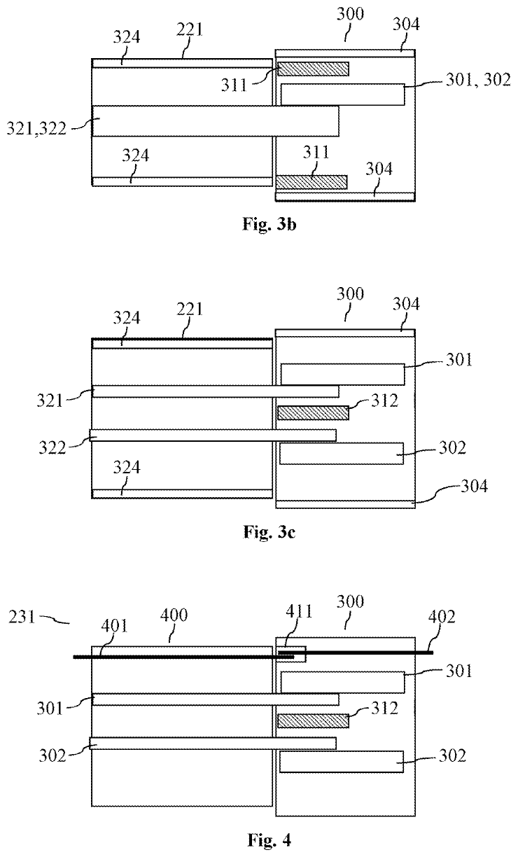

As shown in FIGS. 3a to 3c, a power line 221 can be connected to a plug-in connection element 300, wherein the plug-in connection element 300 is designed to form a plug-in connection 231 with a complementary plug-in connection element 400 (see FIG. 4). The power line 221 typically has multiple (in particular two) conductors 321, 322, for example for a positive potential and for a negative potential. Furthermore, the power line 221 may have a shielding layer or reference layer 324 (e.g., to meet electromagnetic compatibility (EMC) requirements). The reference layer 324 may be at a reference potential (in particular, at vehicle ground).

In a corresponding manner, the plug-in connection element 300 may have contact parts 301, 302, each of which is designed to make electrically conductive contact with one of the conductors 321, 322 of the power line 221. Furthermore, the plug-in connection element 300 may comprise a shielding layer or reference layer 304 which surrounds the contact parts 301, 302 and which can be electrically conductively connected to the shielding layer or reference layer 324 of the power line 221.

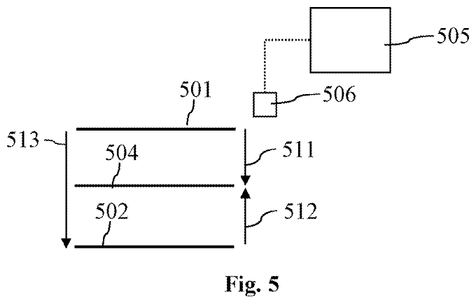

Reference is made to FIG. 5. A first conductor 321 of the power line 221 and/or a first contact part 301 of the plug-in connection element 300 may be at a first potential 501 (e.g., at an HV+ potential). A second conductor 322 of the power line 221 and/or a second contact part 302 of the plug-in connection element 300 may be at a second potential 502 (e.g., at an HV− potential). Further, the protective layer or reference layer 324, 304 of the power line 221 and/or the plug-in connection element 300 may be at a reference potential 504 (e.g., ground).

As shown in FIG. 5, a vehicle 120 may comprise a monitoring device 505 set up to determine resistance data related to the electrical resistance between the different potential planes 501, 502, 504 (e.g., by way of a measuring unit 506). In particular, resistance data can be determined with respect to the first resistance 511 between the first potential plane 501 and the reference plane 504, with respect to the second resistance 512 between the second potential plane 501 and the reference plane 504, and/or with respect to a third resistance 513 between the first potential plane 501 and the second potential plane 502.

The device 505 may further be set up to decouple the power line 221 from the energy store 122 of the vehicle 100 in dependence on the resistance data. In particular, the device 505 may be set up to compare a measured resistance 511, 512, 513 to a first (relatively high) resistance threshold value. If it is identified that the measured resistance 511, 512, 513 is lower than the first resistance threshold value, a message may be issued to the user of the vehicle 100, in particular requesting that the vehicle 100 be serviced.

Furthermore, the device 505 may be set up to compare the measured resistance 511, 512, 513 to a second (relatively low) resistance threshold value (which is lower than the first resistance threshold value). If it is identified that the measured resistance 511, 512, 513 is lower than the second resistance threshold value, then one or more contactors 210 of the vehicle 100 can be opened to disconnect the power line 221 from the energy store 122. In this way, safe operation of the vehicle 100 can be ensured.

As shown from different perspectives in FIGS. 3a to 3c, a plug-in connection element 300 may comprise a protective element 311 designed to change the air gap and creepage distance (and thus the electrical resistance 501, 502) between at least one contact part 301, 302 and the reference or shield layer 304 in dependence on the temperature of the at least one contact part 301, 302. In particular, the protective element 311 may be designed to increase the electrical resistance 501, 502 between the at least one contact part 301, 302 and the reference layer 304 with decreasing temperature or to reduce it with increasing temperature. In this context, the protective element 311 may be designed, e.g., to abruptly reduce the electrical resistance 501, 502 when the temperature of the at least one contact part 301, 302 exceeds a specified temperature threshold value (e.g., 150° C.).

The drop in electrical resistance 501, 502 due to an increase in temperature can be detected by the monitoring device 505. Furthermore, one (of the above-mentioned) protective measures can be initiated in response.

Alternatively or additionally, there can be arranged between the contact parts 301, 302 a protective element 312 which is designed to change the air gap and creepage distance (and thus the electrical resistance 503) between the two contact parts 301, 302 in dependence on the temperature. In particular, the protective element 312 may be designed to increase the electrical resistance 503 between the contact parts 301, 302 with decreasing temperature or to reduce it with increasing temperature. In this context, the protective element 312 may be designed, for example, to abruptly reduce the electrical resistance 503 when the temperature of at least one contact part 301, 302 exceeds the specified temperature threshold value.

A protective element 311, 312 may comprise a dielectric and/or electrically insulating material designed to increase the air gap and creepage distance. The material may be such that the material melts at a specified temperature (in particular at the temperature threshold value) so that the air gap and creepage distance and thus the electrical resistance 501, 502, 503 are reduced.

Alternatively or additionally, the protective element 311, 312 may comprise a bimetal designed to reduce the air gap and creepage distance by curving the bimetal with increasing temperature. For example, the bimetal may move from one contact part 301, 302 toward the reference layer 304 or toward the other contact part 301, 302 as the temperature increases, possibly until electrically conductive contact is effected.

The described plug-in connection element 300, 400 may thus be designed to effect a conductive connection between a contact part 301, 302 and the reference layer 304 (in particular with the vehicle ground) in the presence of an overload. If the temperature is too high, the protective element 311, 312 (e.g., an insulator between the contact part 301, 302 and the reference layer 304) may melt away, causing a reduction in the electrical resistance 501, 502 or a short circuit between the contact part 301, 302 and the reference layer 304 or between the first or second potential 501, 502 and the reference potential 504. This may be identified by the monitoring device 505 (in particular by an insulation monitor). The high-voltage network can be switched off in response (in particular by disconnecting the energy store 122).

Alternatively or additionally, the described plug-in connection element 300, 400 may be designed to effect a conductive connection between the two contact parts 301, 302 in the presence of an overload. If the temperature is too high, the protective element 312 (in particular an insulator) between the contact parts 301, 302 may melt away, causing a reduction of the electrical resistance 503 or a short circuit between the contact parts 301, 302 or between the first and the second potential 501, 502. This may be identified by the monitoring device 505 (in particular by an overcurrent monitor). The high-voltage network can then be switched off.

FIG. 4 shows a plug-in connection 231 having a first plug-in connection element 300 and a second plug-in connection element 400, each of which may be formed as described herein. The two plug-in connection elements 300, 400 may each comprise a safety line 401, 402, wherein the safety lines 401, 402 are electrically conductively connected to each other when the two plug-in connection elements 300, 400 are plugged together to form the plug-in connection 231.

The monitoring device 505 may be set up to check whether the safety lines 401, 402 are electrically conductively connected to each other. If it is identified that the safety lines 401, 402 are not (or are no longer) electrically conductively connected to each other, a disconnection of the HV network can be effected (e.g., by opening the one or more contactors 210).

At least one of the plug-in connection elements 300, 400 may have a protective element 411 designed to interrupt the conductive connection between the safety lines 401, 402 when the temperature increases above the temperature threshold value. For this purpose, the protective element 411 may comprise, e.g., a melting metal that melts when the temperature threshold value is reached. Alternatively or additionally, the protective element 411 may comprise a bimetal as part of a safety line 402 designed to move away from the other safety line 401 as the temperature increases to break the conductive connection between the safety lines 401, 402.

Thus, a plug-in connection element 300, 400 may be designed such that an overload results in an interruption of the safety loop (i.e., the safety lines 401, 402) of the plug-in connection 231. An overtemperature can cause the bridge 411 of the safety loop to melt through in the plug-in connection element 300, 400. This can be identified by the monitoring device 505. The high-voltage mains can then be switched off.

The present invention is not limited to the exemplary embodiments presented. In particular, it should be noted that the description and the figures are intended merely to illustrate the principle of the proposed methods, devices and systems.

1.-12. (canceled)

13. A plug-in connection element for a plug-in connection, the plug-in connection element comprising:
an electrically conductive first contact part which is configured to form an electrically conductive connection with a complementary first contact part of a complementary plug-in connection element of the plug-in connection;
a further electrically conductive part; and
a protective element which is configured to reduce an electrical resistance between the first contact part and the further part as a temperature increases.

14. The plug-in connection element according to claim 13, wherein
the further part comprises a reference part; and
the reference part is connected to a reference potential.

15. The plug-in connection element according to claim 14, wherein the reference part is a reference layer surrounding the first contact part.

16. The plug-in connection element according to claim 14, wherein the reference potential is ground.

17. The plug-in connection element according to claim 13, wherein the further part comprises an electrically conductive second contact part is configured to form an electrically conductive connection with a complementary second contact part of the complementary plug-in connection element of the plug-in connection.

18. The plug-in connection element according to claim 13, wherein the protective element is configured to abruptly reduce the electrical resistance between the first contact part and the further part as soon as the temperature reaches or exceeds a predefined temperature threshold value.

19. The plug-in connection element according to claim 13, wherein
the protective element comprises at least one of a dielectric or an electrically insulating material;
the protective element is arranged between the first contact part and the further part; and
the protective element is configured to melt as soon as the temperature reaches or exceeds a predefined temperature threshold value.

20. The plug-in connection element according to claim 13, wherein
the protective element comprises a bimetal;
the protective element is arranged between the first contact part and the further part; and
the bimetal of the protective element is configured to effect an electrically conductive connection between the first contact part and the further part as soon as the temperature reaches or exceeds a predefined temperature threshold value.

21. A plug-in connection element for a plug-in connection, the plug-in connection element comprising:
an electrically conductive first contact part which is configured to form an electrically conductive connection with a complementary first contact part of a complementary plug-in connection element of the plug-in connection;
a safety line which is configured to form an electrically conductive connection with a complementary safety line of the complementary plug-in connection element of the plug-in connection when the first contact part is electrically conductively connected to the complementary first contact part; and
a protective element which is configured to increase an electrical resistance between the safety line and the complementary safety line as a temperature increases.

22. The plug-in connection element according to claim 21, wherein the protective element is configured to abruptly increase the electrical resistance between the safety line and the complementary safety line as soon as the temperature reaches or exceeds a predefined temperature threshold.

23. The plug-in connection element according to claim 21, wherein
the protective element comprises an electrically conductive material;
the protective element is arranged between the safety line and the complementary safety line; and
the protective element is configured to melt as soon as the temperature reaches or exceeds a predefined temperature threshold value.

24. The plug-in connection element according to claim 21, wherein
the protective element comprises a bimetal arranged between the safety line and the complementary safety line; and
the bimetal of the protective element is configured to interrupt the electrically conductive connection between the safety line and the complementary safety line as soon as the temperature reaches or exceeds a predefined temperature threshold value.

25. The plug-in connection element according to claim 21, wherein at least one of:
the plug-in connection element is configured for electrical voltages of 300V or higher;
the plug-in connection element is configured for electrical currents of 1 A or more;
the plug-in connection element is configured for installation in a vehicle; or
the plug-in connection element is configured for installation in a power path of an electrical prime mover of an electrically driven vehicle.

26. A device for monitoring the plug-in connection element according to claim 21, wherein the plug-in connection element is electrically conductively coupled to an electrical energy store, and the device is configured:
to detect resistance data relating to the electrical resistance influenced by the protective element of the plug-in connection element; and
to decouple the plug-in connection element from the energy store in dependence on the resistance data.

27. The device according to claim 26, wherein the device is configured to decouple the plug-in connection element from the energy store when the electrical resistance is greater than or less than a resistance threshold value.
